(19) United States
(12) Patent Application Publication
(10) Pub. No.: US 2022/0146856 A1
(43) Pub. Date: May 12, 2022

(54) HEAD-MOUNTED DISPLAY APPARATUS

(71) Applicant: OXSIGHT LTD, Oxford, Oxfordshire (GB)

(72) Inventors: Stephen HICKS, Oxford (GB); Noah RUSSELL, Oxford (GB)

(21) Appl. No.: 17/430,636

(22) PCT Filed: Feb. 14, 2020
(86) PCT No.: PCT/GB2020/050354

§ 371 Date: Aug. 12, 2021

(30) Foreign Application Priority Data
Feb. 15, 2019 (GB) 1902163.3
Feb. 15, 2019 (GB) 1902164.1

(51) Int. Cl. G02C 7/00; H04N 13/344; H04N 13/239; G06F 1/16

(52) U.S. Cl. CPC G02C 7/00; H04N 13/344; G02C 2202/10; G06F 1/163; H04N 2213/008; H04N 13/239

(57) ABSTRACT

A head mountable imaging apparatus (5) for assisting a user with reduced vision comprises a first display device (20) configured to provide a display to a first eye of the user. A first lens (27) is provided on a user side of the first display device (20). The first lens (27) is configured to form a focused image of the first display device (20). A first camera (25) is configured to provide an output representing a scene in front of the imaging apparatus (5). A processor (40) is configured to receive the output from the first camera (25), to perform one or more image enhancements to improve vision for the user and to provide a processed output to the first display device (20) for display to the user. The first display device (20) is circular or elliptical.

### TECHNICAL FIELD

The present invention relates to a portable imaging apparatus for assisting a user with reduced vision.

### BACKGROUND

People with central vision loss (CVL) often retain one or more regions of residual vision. In the case of CVL, this region of remaining vision is peripheral to the fovea, which is the normally high detail and high spatial acuity region of the central macular. Peripheral vision is good for detecting moving objects and objects that are relatively dim. However, the lower spatial resolution of the peripheral vision means that an individual with only peripheral vision struggles to differentiate individual visual features. Generally this means that reading (in the periphery) is a particular challenge as adjacent letters in a word interfere with each other. In addition, faces are difficult to clearly see because the features (e.g. eyes, nose, mouth) become blurred.

It is known to provide a headset to assist a user who suffers from a vision defect. Some issues with headsets are that the headsets can be physically large and bulky, or may have a limited field of view. This makes the headset difficult and uncomfortable to use.

Some headsets may present the user with images which are at a different scale to the surrounding environment. This causes difficulties with navigation due to mismatches in optic flow of the visual scene.

It is an aim of the present invention to address at least one disadvantage associated with the prior art.

### SUMMARY OF THE INVENTION

An aspect provides a head mountable imaging apparatus for assisting a user with reduced vision comprising:
a first display device configured to provide a display to a first eye of the user;
a first lens provided on a user side of the first display device, the first lens configured to form a focused image of the first display device;
a first camera configured to provide an output representing a scene in front of the imaging apparatus;
a processor configured to receive the output from the first camera, to perform one or more image enhancements to improve vision for the user and to provide a processed output to the first display device for display to the user,
wherein the first display device is circular or elliptical.

An advantage of at least one example is an imaging apparatus which is physically compact. For example, providing a circular or an elliptical display device can reduce the bulk of the optics required in front of the display device. This can improve user comfort (e.g. a smaller and/or lighter apparatus) and can allow the imaging apparatus to be worn for longer periods. An advantage of at least one example is an imaging apparatus with a wide field of view which matches the natural range of eye movements. An advantage of at least one example is an imaging apparatus with reduced distortion.

Optionally, the imaging apparatus comprises a first tubular element which surrounds the first display device and the first lens, with the first lens located at an eye-facing end of the first tubular element. The first tubular element may provide a light tight shield. The first lens may be supported by the first tubular element.

The tubular element can provide a light tight shield for blocking stray light in order to keep the contrast of the displays as high as possible. High contrast is important for partially-sighted people due to a common degradation in contrast sensitivity. As the first lens is supported by the first tubular element, the frame or housing of the imaging apparatus can have an open region to the side of the first lens, as the frame or housing does not have to provide support for the lens in this region. This allows a user to view the surrounding environment to the side of the display with their peripheral vision. As described above, users with central vision loss (CVL) often retain peripheral vision. The imaging apparatus also has a second tubular element, with the same features, for a second display and second lens.

Optionally, the imaging apparatus comprises an open region adjacent to the first lens such that a user is able to view a combination of an image on the first display device and surrounding environment outside the imaging apparatus.

The open region has an advantage of keeping the periphery clear for general spatial awareness, object location and obstacle avoidance. It has an advantage of reducing the feeling of isolation from the external world that is normally associated with a shielded headset type of imaging apparatus. The open region has an advantage of reducing nausea because motion sickness is strongly associated with peripheral vision. Keeping it open allows zero-latency motion in the periphery. The open region has an advantage of improving airflow, preventing uncomfortable heat and moisture.

Optionally, the first display device is an opaque display device which does not allow a user to see through the display device. The user can only view what is displayed on the first display device (and the second display device) and the surrounding environment to the side of the first display device (and the second display device). This contrasts with headsets intended for Augmented Reality or Mixed Reality, where a user can see the real world through a display device, and views a combination of an image on the display device and the real world visible through the display device.

Optionally, the first camera has a first image sensor, and wherein the processor is configured to obtain the output from a selected region of the first image sensor which is a subset of an overall area of the first image sensor.

Optionally, the first image sensor has a rectangular shape.

Optionally, the image sensor has an x-axis and a y-axis and wherein the processor is configured to vary the position of the selected region in at least one of the x-axis and the y-axis.

Optionally, the processor is configured to vary a size of the selected region.

Optionally, the first camera is positioned on an outer, forward-facing, side of the imaging apparatus in front of the first display device.

Optionally, the first camera is aligned with a central axis of the first display device.

Optionally, the first camera is substantially aligned with an optical axis of the user's first eye.

Optionally, the first lens is a Fresnel lens, an aspheric lens or a plano convex lens.

Optionally, a distance between the first display and the first lens is less than a diameter or height of the first display. An example range of values of the distance between the first display and the first lens is between one half and two thirds of the diameter or height of the first display. Other values are possible.

Optionally, the imaging apparatus is configured to display an image having a first angular field of view of the scene on the first display device, and the imaging apparatus is configured to provide to the user an angular field of view of the first display device which is the same as the first angular field of view. That is, the imaging apparatus is configured to provide to the user an angular field of view of the image displayed on the first display device which is the same as the first angular field of view.

Optionally, the imaging apparatus comprises a second display device which is circular or elliptical. The second display device may have any of the features described for the first display device.

The imaging apparatus may have a single camera, or may have multiple cameras, such as a camera dedicated to providing a display for each eye. The camera, or cameras, may be positioned on-axis (i.e. aligned with a central axis of the circular or elliptical display device) or positioned off-axis.

Optionally, a second camera is positioned on an outer, forward-facing, side of the imaging apparatus in front of the second display device.

Optionally, the second camera is aligned with a central axis of the second display device.

Optionally, the second camera is substantially aligned with an optical axis of the user's second eye.

An advantage of at least one example is an imaging apparatus with a unity gain factor between the first angular field of view (of the scene on the first display device) and the angular field of view of the second display device provided to the user. This has an advantage of reduced distortion. It can also allow a more seamless transition between what the user sees via the display device and what the user sees in the surrounding environment.

The imaging apparatus can be implemented as a pair of glasses with a frame and arms which locate over a user's ears. Other possible implementations include goggles or a visor with a restraint such as an elasticated strap or a band to fit around the user's head.

The functionality described here can be implemented in hardware, software executed by a processing apparatus, or by a combination of hardware and software. The processing apparatus can comprise a computer, a processor, a state machine, a logic array or any other suitable processing apparatus. The processing apparatus can be a general-purpose processor which executes software to cause the general-purpose processor to perform the required tasks, or the processing apparatus can be dedicated to perform the required functions. Another aspect of the invention provides machine-readable instructions (software) which, when executed by a processor, perform any of the described methods. The machine-readable instructions may be stored on an electronic memory device, hard disk, optical disk or other machine-readable storage medium. The machine-readable medium can be a non-transitory machine-readable medium. The term “non-transitory machine-readable medium” comprises all machine-readable media except for a transitory, propagating signal. The machine-readable instructions can be downloaded to the storage medium via a network connection.

Within the scope of this application it is envisaged that the various aspects, embodiments, examples and alternatives, and in particular the individual features thereof, set out in the preceding paragraphs, in the claims and/or in the following description and drawings, may be taken independently or in any combination. For example features described in connection with one embodiment are applicable to all embodiments, unless such features are incompatible.

For the avoidance of doubt, it is to be understood that features described with respect to one aspect of the invention may be included within any other aspect of the invention, alone or in appropriate combination with one or more other features.

### BRIEF DESCRIPTION OF THE DRAWINGS

One or more embodiments of the invention will now be described, by way of example only, with reference to the accompanying figures in which:

FIGS. 1-3 show examples of an imaging apparatus;

FIG. 4 shows another example of an imaging apparatus;

FIG. 5 shows image processing functionality in the imaging apparatus;

FIG. 6 shows a camera for use in the imaging apparatus;

FIG. 7 shows a conventional arrangement of a rectangular display and lens;

FIG. 8 shows a relationship between a camera, a display and a lens in the imaging apparatus of FIGS. 1-4;

FIG. 9 shows a relationship between fields of view of the imaging apparatus;

FIGS. 10-12 shows an arrangement of a display and lens for use in the imaging apparatus;

FIG. 13 shows a relationship between parts of the imaging apparatus;

FIGS. 14 and 15 show examples of processing performed by the imaging apparatus.

### DETAILED DESCRIPTION

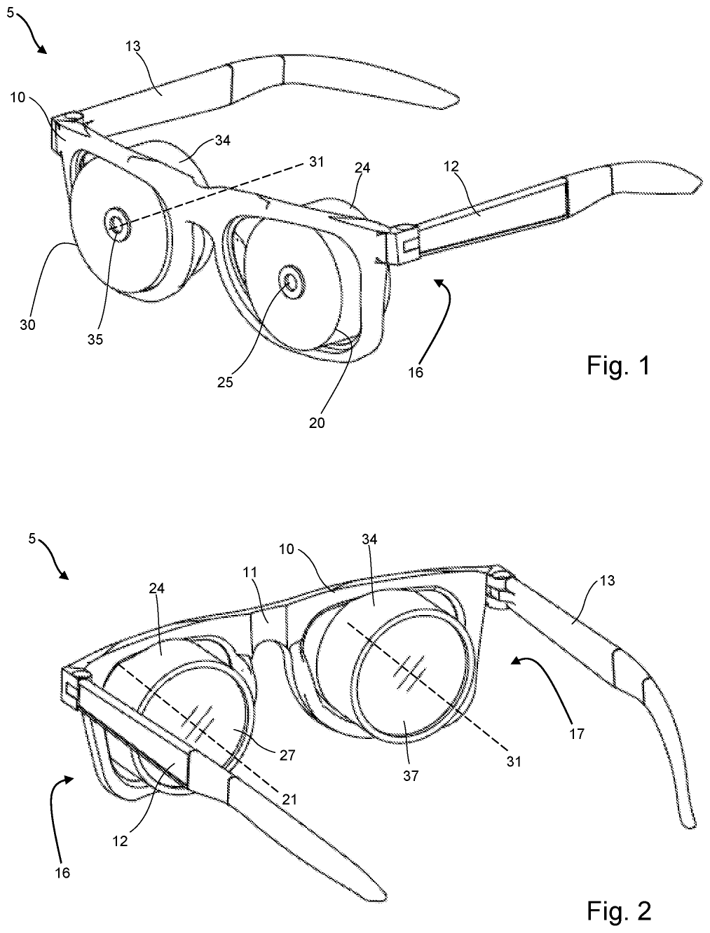

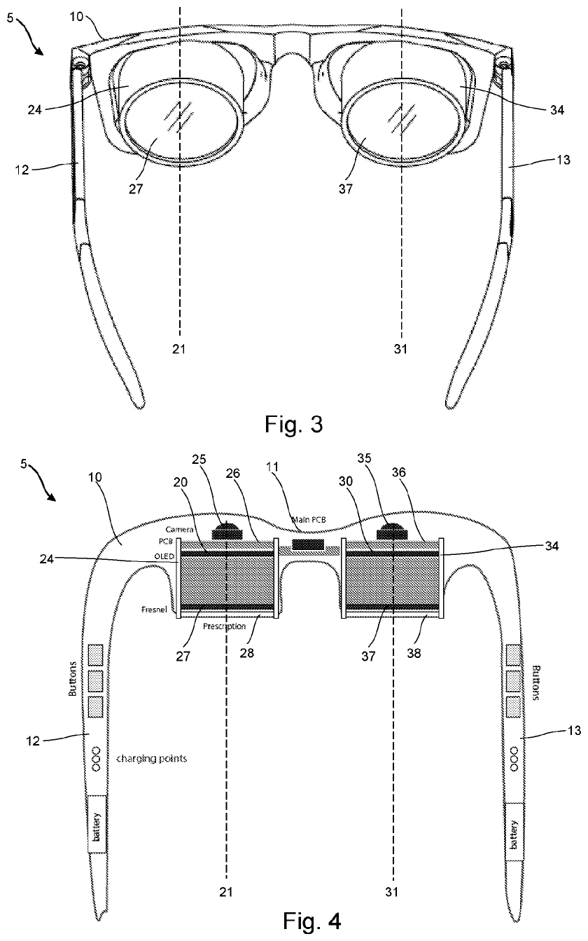

FIGS. 1-4 show examples of an imaging apparatus 5. The imaging apparatus 5 is configured to be worn on a user's head 1. The imaging apparatus 5 shown in these drawings is in the form of a head mountable pair of glasses, but it could be in the form of a headset. The imaging apparatus 5 has a frame 10 or a housing, which is worn in a similar manner to a conventional pair of glasses. The housing/frame 10 has a bridge region 11 which is configured to rest on a user's nose. The housing/frame 10 has a pair of arms 12, 13. Each of the arms 12, 13 is configured to rest on a user's ear.

The imaging apparatus 5 provides each eye of the user with an image representing a view of the surrounding environment in front of the apparatus. In particular, the imaging apparatus 5 provides each eye of the user with an image representing a view of the surrounding environment that a user would normally experience with that eye. A display 20, 30 is provided in front of each of the user's eyes. A first display 20 is provided in front of the user's left eye. A second display 30 is provided in front of the user's right eye. Each display 20, 30 is supported by the frame/housing 10. The position of the displays 20, 30 is best seen in FIG. 4. Each of the displays 20, 30 may use any suitable display technology, such as backlit Liquid Crystal Display (LCD) or Organic Light Emitting Diode (OLED). OLED display technology is advantageous as the display does not require a backlight and therefore can be implemented with reduced physical depth, weight and lower power consumption. It will be understood that the display is opaque. That is, the user only sees an image displayed by the display 20, 30. The user cannot see through the display 20, 30.

Each of the displays 20, 30 has a round shape, such as a circular shape or an oval/elliptical shape. In an example, the diameter of the circular OLED display is 35 mm. Other dimensions are possible. The displays 20, 30 may be the type of round displays used in smart watches, or any other suitable display.

In FIGS. 1-4 a pair of cameras 25, 35 is provided. A first camera 25 is provided on an outer, forward-facing, side of the imaging apparatus in front of the first display device 20. A second camera 35 is provided on an outer, forward-facing, side of the imaging apparatus in front of the second (right) display 30. In this example, each camera 25, 35 is aligned with a central axis 21, 31 of the display 20, 30. Each camera 25, 35 may also be aligned with an optical axis of one of the user's eyes (when the eye is located at a rest position). Each camera 25, 35 provides an output image/video signal. Each camera 25, 35 is configured to provide an output image signal representing a field of view in front of the respective display. The first camera 25 provides an image which represents a view in front of the first (left) display 20. The second camera 35 provides an image which represents a view in front of the second (right) display 30. The use of two spaced-apart cameras 25, 35 provides a user with separate images at their left and right eyes, which can allow a perception of depth in an imaged scene. Visual navigation in the world is greatly assisted by depth perception. Binocular vision allows depth perception from a number of different cues including stereopsis, eye convergence, disparity and parallax.

Referring again to FIG. 4, a display 20 is mounted on a first, eye-facing, side of a printed circuit board (PCB) 26 and a camera 25 is mounted on a second, outward-facing, side of the PCB 26. A first lens 27 is provided on a user-facing side, in front of the first (left) display 20. Similarly, a display 30 is mounted on a first, eye-facing, side of a PCB 36 and a camera 35 is mounted on a second, outward-facing, side of the PCB 36. A second lens 37 is provided on a user-facing side, in front of the second (right) display 30. Each lens 27, 37 is spaced apart from the respective display 20, 30. Each lens 27, 37 is a compact lens, such as a Fresnel lens, an aspheric lens or a plano convex lens. These types of lens may be moulded from lightweight materials, such as a polymeric material (e.g. plastic). This also has an advantage of reducing cost. The lenses 27, 37 have a short focal length. This allows each lens 27, 37 to be positioned close to the display 20, 30. Each display 20, 30 lies in, or near to, the focal plane of the respective lens 27, 37. The lenses 27, 37 allow the imaging apparatus 5 to be as physically compact as possible, compared to a conventional use of single spherical lens or multi element spherical lenses. This allows a lens with a very low F/# (typically ½-⅔) to be used and results in a more compact display. As shown in FIG. 11, in some examples, the distance between the display 20, 30 and lens 27, 37 is ½-⅔ of the diameter D of the display 20, 30.

Each lens 27, 37 is round and advantageously is slightly larger than the display. For example a 40 mm diameter lens may be used with a 35 mm diameter display. Each display 20, 30 is placed within, or near, the focal plane of the lens. This allows the full area of the display to be viewed and results in an image focused far away when placed close to the eye.

A first tubular element 24 surrounds the display 20 and the lens 27, maintaining the lens 27 at a fixed distance from the display 20. The lens 27 is supported by the first tubular element 24. No other part of the frame 10 or housing is required to support the first lens 27. The display (or the PCB 26 on which the display 20 is mounted) is located at the outward-facing end of the tubular element 24. The fresnel lens 27 is located at, or close to, the eye-facing end of the tubular element 24. A region of empty space separates the display 20 and the lens 27. The first tubular element 24 may also provide a light tight shield between the lens 27 and the display 20. That is, the only optical path to/from the display is via the lens 27. This prevents stray light from reaching the display 20. This can improve readability of the display, especially under bright conditions while avoiding the need to fully isolate the user from the surrounding environment in the manner of a conventional shielded headset. High contrast is important for partially-sighted people due to a degradation in contrast sensitivity. A second tubular element 34 provides the same functions for the right eye display 30 and lens 37.

The imaging apparatus 5 comprises an open region 16 adjacent to the first lens 27. The open region 16 is to the left hand side of the first lens 27. Similarly, the imaging apparatus 5 comprises an open region 17 adjacent to the second lens 37. The open region 17 is to the right hand side of the first lens 27. Instead of shielding the user from the surrounding environment, the user can view a combination of an image on the first display device (via the lens 27) and the surrounding environment outside the imaging apparatus. Similarly, the user can view a combination of an image on the second display device (via the lens 37) and the surrounding environment outside the imaging apparatus. The open region has an advantage of keeping the periphery clear for general spatial awareness, object location and obstacle avoidance. It has an advantage of reducing the feeling of isolation from the external world that is normally associated with a shielded headset type of imaging apparatus, and can reduce nausea. The open region has an advantage of improving airflow, preventing uncomfortable heat and moisture.

A prescription lens 28, 38 may also be provided. The prescription lens may compensate for short-sightedness (myopia), far-sightedness (hyperopia) and/or some other condition. In FIG. 4 a first prescription lens 28 is shown in front of the fresnel lens 27, and a second prescription lens 38 is shown in front of the fresnel lens 37. Depending on a user's needs, a prescription lens may only be present for the left eye or the right eye. Where tubular elements 24, 34 are used, the prescription lens, or lenses, may be supported by the tubular elements 24, 34. For example, prescription lens 28 may locate within the eye-facing end of the tubular element 24.

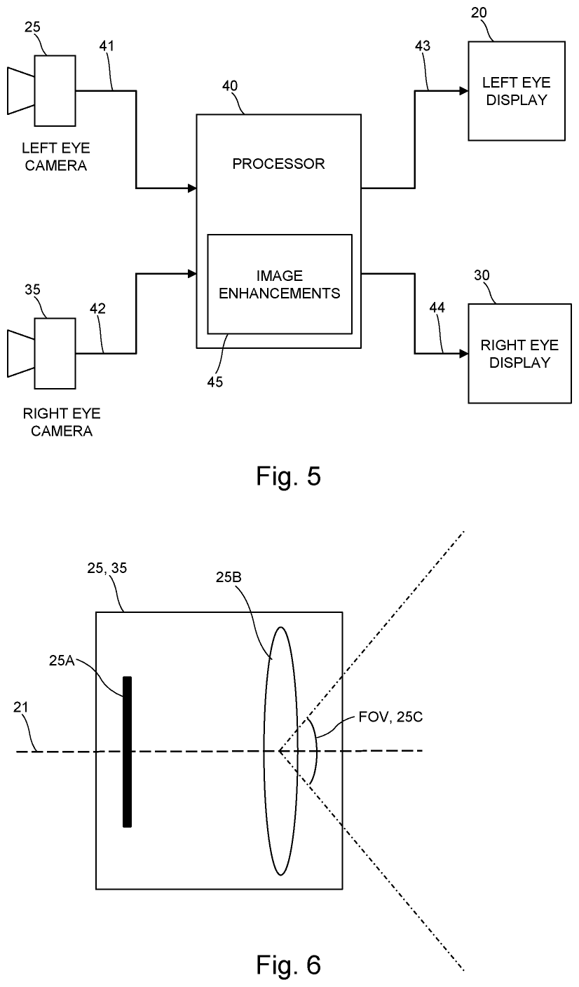

FIG. 5 schematically shows image processing functionality of the imaging apparatus 5. A processing unit 40 is configured to receive an image/video signal 41 from the left eye camera 25 and receive an image/video signal 42 from the right eye camera 35. The processing unit 40 may improve vision for the user by computationally enhancing a live image of the environment. Processing unit 40 may provide one or more image enhancements 45 to the image signal received from the cameras 25, 35. The processing unit 40 outputs a processed image/video signal 43 to the left eye display 20 and outputs a processed image/video signal 44 to the right eye display 30. The image enhancements may comprise one or more of: edge detection and presentation of the detected edges (e.g. as white edges on a black background, as white edges overlaid upon a colour or a grayscale image); an enhanced contrast between features of the image; a black and white high-contrast image with a global threshold that applies to the entire screen; a black and white high contrast image with multiple regional thresholds to compensate for lighting changes across a screen; an algorithm to detect large regions of similar hues (e.g. regardless of brightness) and then presenting these regions as high brightness swatches of the same colour. Other enhancements or image processing may be performed by the processing unit 40. Other processing functions include one or more of: magnification or minification, display of a high resolution static image, presentation of a picture-within-picture. The type of enhancement(s)/processing performed by the processing unit 40 may depend on the vision defects of the user.

One possible location for the processing unit 40 is the bridge region 11 of the frame/housing 10. Another possible location for the processing unit 40 is in one, or both, of the arms 12, 13. The imaging apparatus 5 may comprise a local power source, such as at least one battery housed in one, or both, of the arms 12, 13.

FIG. 6 shows the camera 25 in more detail. Camera 35 is the same as camera 25. The camera 25 comprises an image sensor 25A and a lens, or lens array, 25B. The lens 25B of the camera forms a focused image on the image sensor 25A. The lens 25B has a field of view (FOV) 25C.

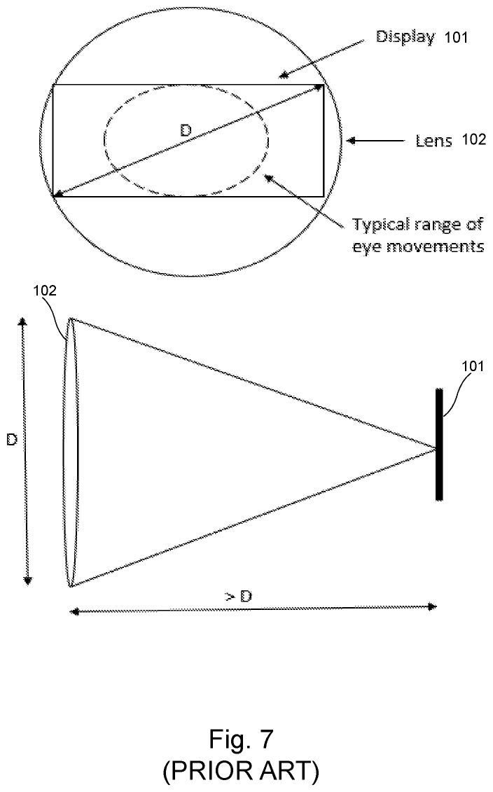

For comparison purposes, FIG. 7 illustrates conventional apparatus used in Virtual Reality (VR) or Augmented Reality (AR) applications. A rectangular display 101 is used with a macroscopic round lens 102. The lenses 102 used are required to produce a high-resolution image over a wide field of view with low field curvature and other aberrations. So, typically, either complex multicomponent lenses, or a customised molded aspheric lens, is required. This leads to significant compromises in form factor because the shape of the display and the lens are mismatched. The diameter of the lens 102 has to be at least as large as the diagonal of the display 101 in order to be able to view the entire display 101. In addition, the lenses 102 required have a relatively large F/# (>1). This results in the distance between the lens and the display being larger than the diagonal size of the display (typically by at least 1.5 to 2×). Both of these factors result in a large distance between the display and the lens and therefore result in either a large bulky headset or a small display with a small field of view.

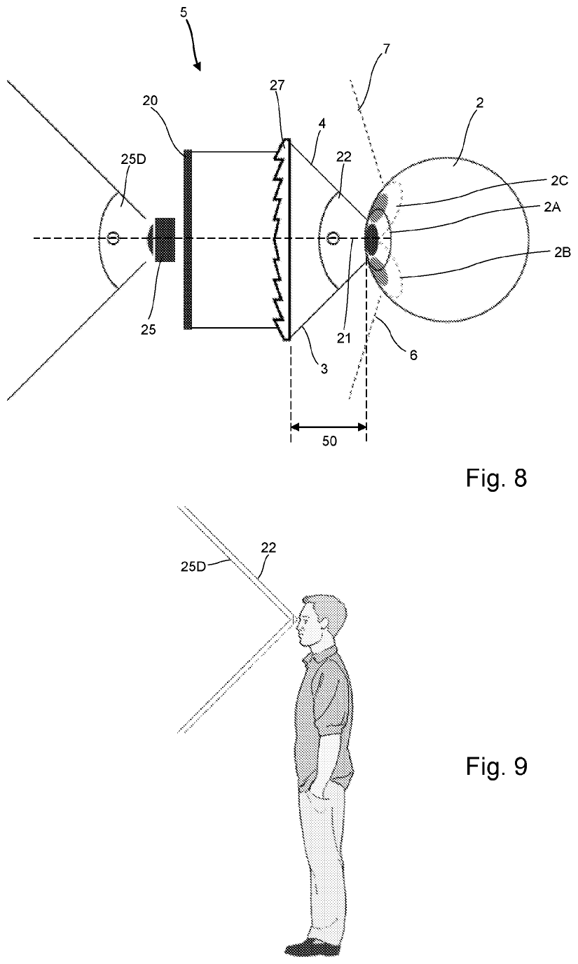

FIG. 8 illustrates an optical and a physical relationship of the components of the imaging apparatus. The relationships of the imaging apparatus shown in FIG. 8 can apply to the horizontal (x) plane (i.e. FIG. 8 can be understood as showing a top view of the apparatus) and to the vertical (y) plane (i.e. FIG. 8 can be understood as showing a side view of the apparatus). The angular ranges are wider in the horizontal plane compared to the vertical plane, but the same relationships apply. The imaging apparatus 5 comprises a display 20, a camera 25 and a Fresnel lens 27. The Fresnel lens 27 is positioned between the user's eye 2 and the display 20.

FIG. 8 shows three eye positions 2A, 2B, 2C. Position 2A is a central position of the eye. In this central (or rest) position 2A, the main optical axis of the eye is aligned with a centre of the lens 27, display 20 and camera 25. The lens 27, display 20 and camera 25 are co-aligned with the same axis. Positions 2B, 2C represent positions at the limits of comfortable eye movement under normal conditions. Lines 6 and 7 represent the edges of the field of view for positions 2B, 2C. The eye can rotate further than positions 2B, 2C but this is generally uncomfortable. Usually, if the user wishes to view outside of the comfortable viewing range they will rotate their head to bring the eye position back to within this comfortable range. Typically, the range of eye movement is restricted to an elliptical region extending between +20 degrees and −20 degrees in the horizontal plane and between +15 degrees and −15 degrees in the vertical plane. These angles relate to the angular distance between the main optical axis in positions 2B, 2C and the main optical axis in a rest position (position 2A). Beyond this angular range of movement, a user typically moves their head (rather than their eyes) to reorient.

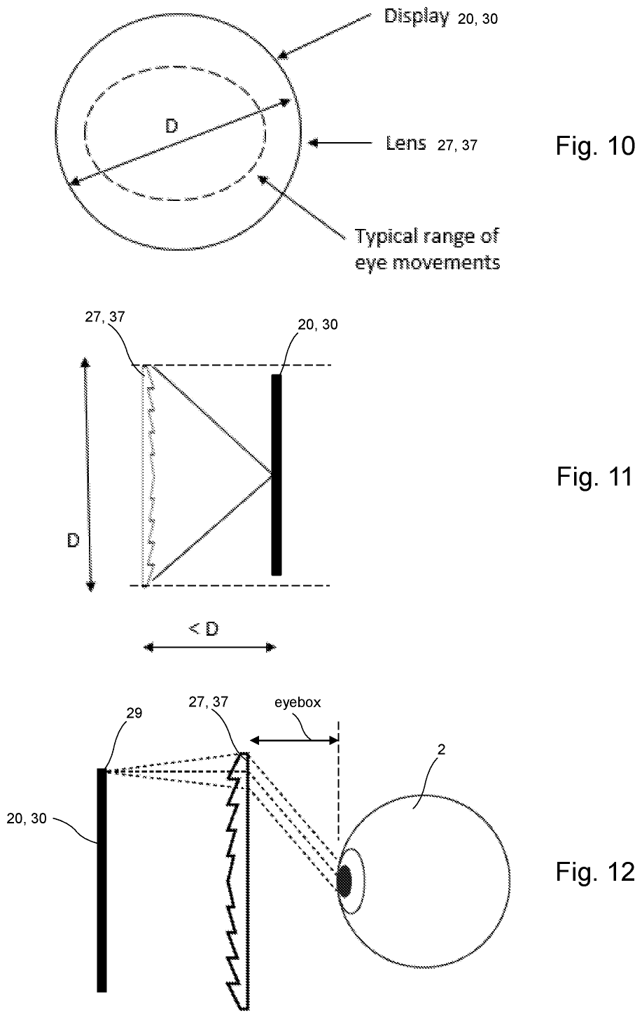

FIG. 10 shows an elliptical region representing a typical range of eye movement, superimposed upon the circular display 20, 30. The region of typical eye movement lies within the circular display 20, 30.

FIG. 11 shows a relationship between the Fresnel lens 27, 37 and the display 20, 30. The diameter D of the lens 27, 37 is less than the distance between the lens 27, 37 and the display 20, 30.

Advantageously the display 20, camera 25 and Fresnel lens 27 are all aligned, and are aligned with a main optical axis 21 of the user's eye 2. The Fresnel lens 27 is positioned within a field of view (FOV) of the user's eye. The lens 27 allows the user's eye to form a focused image of the display 20.

An aim of the imaging apparatus 5 is to appear, to the user, as if there is nothing but an empty glasses frame in front of their eye. To achieve this, the FOV 22 of the lens 27 and display 20 as seen by the user's eye is matched to the FOV 25D of the scene displayed on the display 20. This gives a system magnification of 1× (unity) in terms of angular field of view. The relationship between the FOV 22 and FOV 25D is shown by FIG. 9.

In conventional Virtual Reality (VR)/Augmented Reality (AR) imaging there is often a mismatch between the viewing angle of cameras and the viewing angle of their displays. This provides further difficulties with navigation due to mismatches in the optic flow of the visual scene. Close objects move faster in the visual field than distant objects. When the image on the display is zoomed in, and at a greater size than real life, the increased optic flow makes everything appear to be closer than it is.

The user typically experiences a discontinuity between their view of the display 20, 30 and their view past the edge of the display 20, 30 due to distortions in the image. The discontinuity in the optic flow may induce nausea and make navigation around the world challenging. It may also make it difficult to perform tasks requiring hand-eye coordination.

In the imaging apparatus 5, the effects of this optical discontinuity are reduced. A user experiences a system magnification of unity by matching the camera focal length and chip size, to the display size and lens focal length. Fine adjustments to the system magnification are made digitally. This ensures that peripheral vision past the edge of the display and the image on the display are continuous. The user is able to then use peripheral vision with no mismatch in position, scale or flow of objects as they pass the boundary from peripheral vision to the display. The discontinuity at the boundary of the apparatus may be similar to that experienced at a frame of a conventional pair of glasses.

The user's field of view FOV 22 of the lens 27, and the display 20 beyond the lens 27, is determined by factors such as the size of the lens 27, the size of the display 20 and the distance 50 between the lens 27 and the eye 2. As explained above, the eye 2 has a wider overall FOV than FOV 22. The extent of the wider FOV of the eye is shown by the dashed lines 6, 7. When the eye is located in one of the extreme positions 2B, 2C the user's gaze is directed approximately one third of the way across the display 20. The full display 20 will still be visible within the user's peripheral vision. The world beyond the edge of the lens 27 will also be visible in the user's peripheral vision, assuming the glasses frame does not obstruct this. This is true even when the gaze is directed straight ahead. Rotation of the eye 2 effectively translates the pupil, and the edge of the lens 27 effectively acts as a window that the display 20 is viewed through. This means that as the eye rotates the view of the display 20 will appear to be cropped differently. If the eye is rotated to the left then the display will be cropped on the left hand edge. By configuring the lens 27 with a larger diameter than a diameter the display 20, this effect should be minimised or negligible.

Referring to FIG. 12, any point source of light (in this case a pixel 29 on display 20, 30) will emit light in all (many) directions. A few representative rays are shown. If the point source lies in the focal plane of the lens (as it is in this case) then the diverging rays from a point will exit the lens parallel to each other. These parallel rays are then focused by the lens in the eye 2 to a corresponding image point on the retina. The collection of a range of diverging rays from a point source by a lens, and their subsequent refocusing to a point, is a necessary requirement to form an image. For a point at the centre of the display 20, the lens 27 captures a much wider range of rays compared to a pixel located at the periphery of the display 20. In principle, this means the centre of the image would appear to be much brighter than the periphery. However, in this case, the pupil of the eye 2 limits the set of rays that contribute to the image formation. This means that if we make the diameter of lens 27 larger than the diameter of the display 20 by the size of the pupil (actually the size of the eyebox because the pupil can move anywhere within the eyebox), then a reasonable image can be formed, with uniform brightness across the whole of the image. The eyebox is the three dimensional region in front of the lens within which the user can see a reasonable image. So, if the eyebox has a dimension of 5 mm, then the pupil will need to be within this 5 mm region for the optimal view.

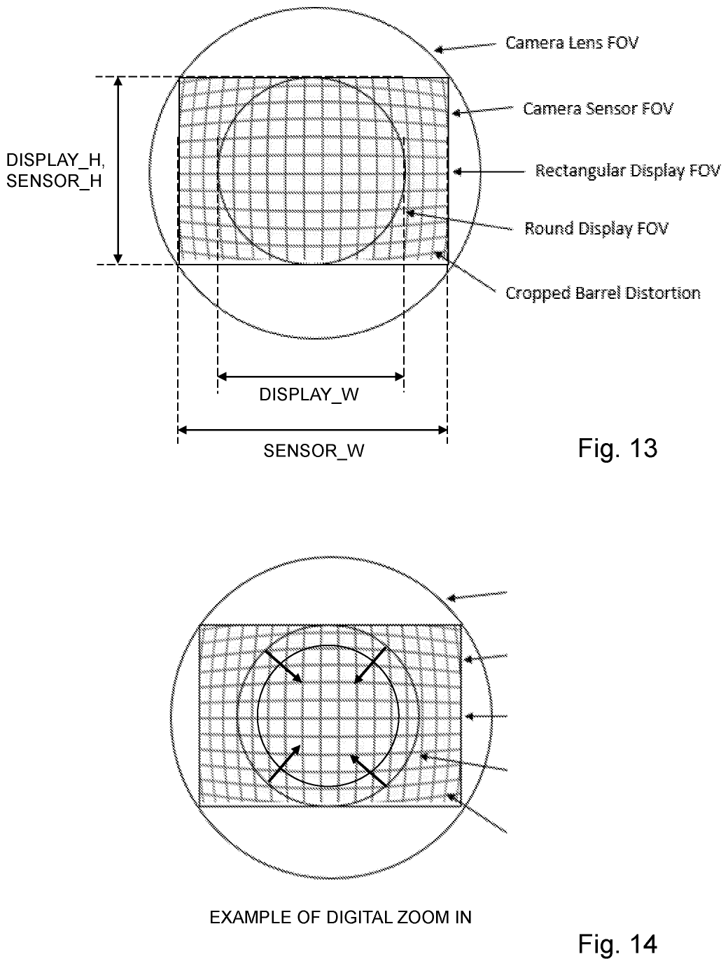

As explained above, the scene displayed on the display 20 has a FOV 25D. Referring again to FIG. 6, the lens 25B of the camera 25 collects light over a wider FOV 25C. The lens 25B projects an image onto the image sensor 25A. The projected image is as wide as, or wider than, the image sensor 25A of the camera 25. By providing a FOV 25C which is wider than the FOV 25D, the image can be cropped to match the FOV of the display 20 and/or lens 27 as seen by the eye (theta). This wider camera FOV 25D can also be used for translation and/or digital zooming to calibrate for the user. This is explained in more detail in FIGS. 13-15.

The circular display 20 displays an image which is selected from a region of the image sensor 25A. Stated another way, the image sensor 25A is cropped to provide the image for display. FIG. 13 shows the circular display FOV superimposed upon the image/camera sensor FOV.

FIG. 13 is showing the relationship between the FOV of the image displayed by the display 20 compared to the FOV of the image on the image sensor. The image sensor 25A typically has smaller physical dimensions than the display 20. It should be understood that FIG. 13 does not show a relationship of the physical dimensions of the image sensor 25A and the display 20 but, instead, shows a relationship between FOVs of the image sensor 25A and the display 20.

In FIG. 13 the display FOV has a height (DISPLAY_H) and a width (DISPLAY_W). The image sensor FOV has a height (SENSOR_H) and a width (SENSOR_W). The display FOV has a height (DISPLAY_H) which is substantially the same as the height (SENSOR_H) of the image sensor FOV, and the display FOV has a width (DISPLAY_W) which is less than a width (SENSOR_W) of the image sensor FOV.

A position of the cropped region of the image sensor 25A may be selected by the processing unit 40. For example, the cropped region used for output to the display 20 may be moved in the x-axis and/or y-axis.

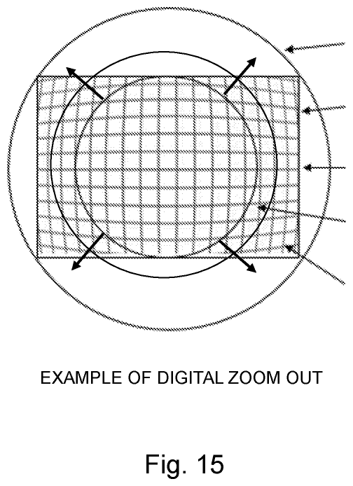

The size of the cropped region may be varied by the processing unit 40. Size may be varied by a digital zoom operation, i.e. a digital domain manipulation of the mapping between the pixels of the image sensor 25A and the pixels of the display 20. A digital zoom in function is shown in FIG. 14. To perform a digital zoom in, a pixel of the image sensor 25A is mapped to a plurality of neighbouring pixels of the display. Interpolation algorithms may be used to improve appearance. A digital zoom in function is shown in FIG. 15. To perform a digital zoom out, a plurality of pixels of the image sensor 25A are mapped to a pixel of the display 20. Digital zooming may be required to compensate for the position of the imaging apparatus relative to the user's eyes. For example, if the eye-to-lens distance is longer than normal, a digital zoom in may be required. Similarly, if the eye-to-lens distance is less than normal, a digital zoom out may be required.

Position and/or size of the displayed region may be selected by manual control. For example, a user can manually enlarge (zoom in) or shrink (zoom out) the image based on their own needs and the visual experience. A user interface to control the zoom function may be provided on the imaging apparatus 5 (e.g. buttons on arms 12, 13, FIG. 4). Additionally, or alternatively, a user interface to control the zoom function may be provided a handheld control unit that may be physically attached (e.g. via a cable) to the imaging apparatus 5. Additionally, or alternatively, a user interface to control the zoom function may be provided on a portable device which communicates wirelessly (e.g. using a wireless transmission protocol such as Bluetooth™). When the user interacts with the control, such as by manipulating a button, knob, slider of graphical user interface (GUI), this instructs the processing unit 40 to enlarge or shrink the image as described above.

In another situation, the zoom level may be preconfigured for the wearer by a qualified technician or clinician based on factors such as: the shape of the user's face; the distance from the eye to the lens 27 when the imaging apparatus is worn by the user.

The camera lens 25B is a wide angle lens. This type of lens inevitably has non-ideal optical properties. FIG. 13 shows the effects of optical barrel distortion on a rectilinear grid. Barrel distortion has the effect of causing straight lines to appear curved. The barrel distortion is worst at the periphery of the FOV, and is most pronounced at the corners of a rectangular image. Barrel distortion (and other forms of optical distortion) may be corrected to some extent in the digital domain by the processing unit 40. However, this is computationally expensive, wastes power and increases the system latency. This is critical for portable and wearable systems. The cropping of the image sensor FOV has an effect of cropping the most heavily distorted region of the camera lens 25B, while avoiding for this computationally expensive processing.

As described above, the imaging apparatus can have a single camera, such as a single camera which is centrally-mounted on the front of the frame 10 or housing. The single camera has a FOV which is sufficient to provide images to each display. For example, to provide a FOV to each eye of 60 degrees, the single camera may have a FOV of 80 degrees. An output of the single camera is processed to provide an image to the left eye display 20 and to the right eye display 30. The images displayed by each display 20, 30 can have the same unity gain factor described above. That is, the left eye display 20 is configured to display an image having a first angular field of view of the scene in front of the left eye on the left eye display device, and the imaging apparatus is configured to provide to the user an angular field of view of the left eye display device which is the same as the first angular field of view. Similarly, the right eye display 30 is configured to display an image having a first angular field of view of the scene in front of the right eye on the right eye display device, and the imaging apparatus is configured to provide to the user an angular field of view of the right eye display device which is the same as the first angular field of view. This gives continuity between the displayed image and the real world, and continuity between the displayed image and the surrounding environment visible through the open regions 16, 17 to the side of the lenses 27, 37.

Another aspect of the disclosure may be understood with reference to the following numbered clauses.
1. A head mountable imaging apparatus for assisting a user with reduced vision comprising:
   a first display device configured to provide a display to a first eye of the user;
   a first lens provided on a user side of the first display device, the first lens configured to form a focused image of the first display device;
   a first camera configured to provide an output representing a scene in front of the imaging apparatus;
   a processor configured to receive the output from the first camera and to provide an output to the first display device for displaying an image to the user,
   wherein the imaging apparatus is configured to display an image having a first angular field of view of the scene on the first display device, and the imaging apparatus is configured to provide to the user an angular field of view of the first display device which is the same as the first angular field of view. That is, the imaging apparatus is configured to provide to the user an angular field of view of the image displayed on the first display device which is the same as the first angular field of view.
2. An apparatus according to clause 1 comprising an open region adjacent the first lens such that a user is able to view a combination of an image on the first display device and surrounding environment outside the imaging apparatus.
3. An apparatus according to clause 1 or 2 wherein the first camera is positioned on an outer, forward-facing, side of the imaging apparatus in front of the first display device.
4. An apparatus according to clause 3 wherein the first camera is aligned with a central axis of the first display device.
5. An apparatus according to clause 4 wherein the first camera is substantially aligned with an optical axis of the user's first eye in a rest position.
6. An apparatus according to any one of the preceding clauses wherein the angular field of view of the first display device provided to a user is based on an expected distance between the first lens and a position of a user's eye.
7. An apparatus according to any one of the preceding clauses wherein the first lens is a Fresnel lens or an aspheric lens.
8. An apparatus according to any one of the preceding clauses wherein a distance between the first display and the first lens is less than a diameter or height of the first lens.
9. An apparatus according to clause 8 wherein a distance between the first display and the first lens is between one half and two thirds of the diameter or height of the first display.
10. An apparatus according to any one of the preceding clauses wherein the first display is circular or elliptical.
11. An apparatus according to any one of the preceding clauses wherein the first camera has a first image sensor, and wherein the processor is configured to obtain the output from a selected region of the first image sensor which is a subset of an overall area of the first image sensor.
12. An apparatus according to clause 11 wherein the first image sensor has a rectangular shape.
13. An apparatus according to clause 11 or 12 wherein the first image sensor has an x-axis and a y-axis and wherein the processor is configured to vary the position of the selected region in at least one of the x-axis and the y-axis.
14. An apparatus according to clause 14 wherein the processor is configured to vary the position of the selected region based on a user input.
15. An apparatus according to any one of clauses 11 to 14 wherein the processor is configured to vary a size of the selected region to adjust the first angular field of view of the image displayed on the first display device.
16. An apparatus according to clause 15 wherein the processor is configured to vary a size of the selected region based on a user input.
17. An apparatus according to any one of the preceding clauses comprising:
   a second display device configured to provide a display to a second eye of the user;
   a second lens provided on a user side of the second display device, the second lens configured to form a focused image of the second display device;
   a second camera configured to provide an output representing a scene in front of the imaging apparatus;
   a processor configured to receive the output from the second camera and to provide an output to the second display device for displaying an image to the user,
      wherein the imaging apparatus is configured to display an image having a second angular field of view of the scene on the second display device, and the imaging apparatus is configured to provide to the user an angular field of view of the second display device which is the same as the second angular field of view.
18. An apparatus according to clause 17 wherein the first angular field of view is equal to the second angular field of view.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics described in conjunction with a particular aspect, embodiment or example of the invention are to be understood to be applicable to any other aspect, embodiment or example described herein unless incompatible therewith.

1. A head mountable imaging apparatus for assisting a user with reduced vision, the apparatus comprising:
a first display device configured to provide a display to a first eye of the user;
a first lens provided on a user side of the first display device, the first lens configured to form a focused image of the first display device;
a first camera configured to provide an output representing a scene in front of the imaging apparatus; and
a processor configured to receive the output from the first camera, to perform one or more image enhancements to improve vision for the user and to provide a processed output to the first display device for display to the user,
wherein the first display device is circular or elliptical.

2. An apparatus according to claim 1, further comprising a first tubular element which surrounds the first display device and the first lens, with the first lens located at an eye-facing end of the first tubular element.

3. An apparatus according to claim 2, wherein the first tubular element provides a light tight shield.

4. An apparatus according to claim 2, wherein the first lens is supported by the first tubular element.

5. An apparatus according to claim 1, wherein the first lens is circular or round.

6. An apparatus according to claim 1, further comprising an open region adjacent the first lens such that a user is able to view a combination of an image on the first display device and surrounding environment outside the imaging apparatus.

7. An apparatus according to claim 1, wherein the apparatus is configured to display an image having a first angular field of view of the scene on the first display device, and to provide to the user an angular field of view of the first display device which is the same as the first angular field of view.

8. An apparatus according to claim 1, wherein a distance between the first display device and the first lens is less than a diameter or height of the first display device.

9. An apparatus according to claim 1, wherein the first display device is an opaque display device which does not allow a user to see through the display device.

10. An apparatus according to claim 1, wherein the first camera has a first image sensor, and wherein the processor is configured to obtain the output from a selected region of the first image sensor which is a subset of an overall area of the first image sensor.

11. An apparatus according to claim 10, wherein the image sensor has a rectangular shape.

12. An apparatus according to claim 10, wherein the image sensor has an x-axis and a y-axis and wherein the processor is configured to vary the position of the selected region in at least one of the x-axis and the y-axis.

13. An apparatus according to claim 10, wherein the processor is configured to vary a size of the selected region of the overall area of the first image sensor.

14. An apparatus according to claim 1, wherein the first camera is positioned on an outer, forward-facing, side of the imaging apparatus in front of the first display device.

15. An apparatus according to claim 14, wherein the first camera is aligned with a central axis of the first display device.

16. An apparatus according to claim 15, wherein the first camera is substantially aligned with an optical axis of the user's first eye.

17. An apparatus according to claim 1, wherein the first lens is a Fresnel lens, an aspheric lens or a plano convex lens.

18. An apparatus according to claim 1, further comprising a second display device which is circular or elliptical.

19. An apparatus according to claim 1, further comprising a second camera configured to provide an output representing a scene in front of the imaging apparatus.

20. An apparatus according to claim 19, wherein the second camera is positioned on an outer, forward-facing, side of the imaging apparatus in front of the second display device.

21. An apparatus according to claim 20, wherein the second camera is aligned with a central axis of the second display device.

22. An apparatus according to claim 21, wherein the second camera is substantially aligned with an optical axis of the user's second eye.
